(19) United States
(12) Patent Application Publication
(10) Pub. No.: US 2009/0250587 A1
(43) Pub. Date: Oct. 8, 2009

(54) Core and a Method for the Production Thereof

(76) Inventors: Dieter Käfer, Igensdorf (DE); Gudrun Schiller, Eckental-Eckenhaid (DE); Gisbert Schulze, Lauf-Heuchling (DE); Peter Stingl, Lauf (DE); Roland Werner, Schwaig-Behringersdorf (DE); Horst Walter Rockenschaub, Leoben (AT); Reinhold Georg Gschwandtner, Leoben (AT); Thomas Pabel, Leoben (AT)

Correspondence Address: FULBRIGHT & JAWORSKI, LLP, 666 FIFTH AVE, NEW YORK, NY, 10103-3198, US

(21) Appl. No.: 11/992,631

(22) PCT Filed: Sep. 29, 2006
(86) PCT No.: PCT/EP2006/066882

§ 371 Date: Mar. 3, 2009

(30) Foreign Application Priority Data
Sep. 30, 2005 (DE) 102005047416.0
Apr. 19, 2006 (DE) 102006018481.5

(51) Int. Cl. B29C 33/38; B28B 7/34

(52) U.S. Cl. 249/175; 264/219

(57) ABSTRACT

The invention relates to core used in a mould for casting metal workpieces or molding by injection plastic workpieces for keeping free hollow spaces arranged in the workpieces when the moulds are filled with material.

The present invention relates to cores and also to a method for producing cores for use as cavity placeholders, in the case of the production of metallic and non-metallic moulded bodies, from substances which are completely soluble in water and can therefore be removed from the moulded bodies without a residue, by means of core-shooting.

High demands are made on cores that are inserted into the moulds when casting work pieces of metal or when injection-moulding work pieces of plastics materials in order to keep the hollow spaces or cavities that are provided in the work pieces free when filling the moulds with the material. The cores must remain dimensionally stable when introducing the material into the mould, during casting or injection, and be able to be removed easily from the hollow space that is provided after the material has solidified.

If cores are required in large piece numbers, for example for mass production in foundries, it is necessary to be able to produce the cores with a quality that is always consistent, in a way that is designed to meet requirements, and within the shortest possible time. If special demands are made on the surface and the precision of the contours of the hollow spaces of the work pieces, the surface of the cores must be particularly smooth and have precise contours, and it must be possible to remove the cores fully without a residue from the hollow spaces of the work pieces. Residues of conventional cores, which do not contain soluble constituents, such as, for example, quartz sand, can result in damage to surfaces that are to be refined or give rise to the failure of a unit, for example if sand residues in the pump housing of an injection pump result in the blockage of an injection nozzle.

The production of moulds and/or cores for foundry purposes from water glass, metal salts that are difficult to dissolve and a non-soluble constituent, where the non-soluble constituent is a heat-resistant, granular material, in particular sand, is known from DE 10 2004 057 669 B3. After casting, the core is converted into a pourable form by mechanical actions and poured out of the hollow space in the dry state. The risk exists with a core of this composition that undesirable residues that are difficult to dissolve remain in the hollow space.

It is therefore the object of the invention to put forward cores that have a homogeneous density, uniform strength and a smooth surface with precise contours and above all can easily be removed from the hollow spaces of the work pieces without a residue by virtue of the fact that they dissolve completely in water, and also to put forward a method for their production.

The object is achieved with cores in accordance with the first claim and also with a method for producing these cores according to claim 16. Advantageous developments of the invention are claimed in the dependent claims.

The cores in accordance with the invention consist of a moulding material and also, if applicable, substances that influence the properties and quality of the cores, such as fillers, binders, additives and catalysts. All of these substances and also the substances that develop as a result of possible reactions form the core material. This core material is completely soluble in water and as a result after shaping can be removed from the hollow spaces of the work pieces without a residue. The cores do not therefore disintegrate into insoluble constituents after the binder has dissolved, but all the substances dissolve completely. All the compositions of the core materials can be processed by core-shooting as the shaping process.

The cores in accordance with the invention have the advantage that they are composed of substances that do not load the environment if handled properly, neither during their production nor during the casting process. When removed from the work pieces no residues develop that require special disposal. Depending on the composition, the substances can be recovered from the liquid phase by suitable methods, for example salt by spray-drying or concentration by evaporation.

The production of the cores in accordance with the invention can be effected with conventional core-shooting machines. The complexity of the geometry of the cores determines the core-shooting parameters and also the configuration and structural design of the tool for the production of the cores and the shooting head of the core-shooting machine. Compared with shaping by pressing, in which the core materials are poured into a form tool and then compressed under pressure, core-shooting on the basis of the transportation of the claimed core materials through the compressing means, the compressed gas, renders possible the production of cores that are set up in a very complicated manner with great precision of their contours on the surface and also a homogeneous structure with uniform density and strength.

The chlorides of alkali and alkaline-earth elements, such as in particular sodium chloride, potassium chloride and magnesium chloride, the water-soluble sulphates and nitrates of alkali and alkaline-earth elements, such as in particular potassium sulphate, magnesium sulphate, and also water-soluble ammonium salts, such as in particular ammonium sulphate, are suitable as moulding material.

These substances can be used individually or even as a mixture, in so far as they do not react with each other and thus negatively affect the desired properties, since the moulding material is not to undergo any substance-conversion during core-production that negatively affects its solubility. Generally all those easily soluble salts are suitable whose point of decomposition or melting point lies above the temperature of the liquid metal, the melt, or the injected plastics material. The moulding materials can, in a manner comparable with that of sand, be easily and simply divided into the desired grain sizes or grain classes. In particular, the finish of the surface of the cores is affected by the selected grain-size distribution. The smaller the grain size is, the smoother the surface is. Generally, a degree of space-filling that is as high as possible is striven for that can be achieved by mixing various salts and, if applicable, the additional substances with different distribution curves, for example by means of a bi- or tri-modal grain distribution of the mixture.

In accordance with the invention, grain sizes in the range of 0.01 mm to 2 mm are selected, preferably as a Gaussian distribution, depending on the material, the desired surface quality and the precision of the contours of the work piece that is to be cast or injection-moulded from plastics material.

Water-soluble fillers can replace a portion of the moulding material, up to 30% by weight, in so far as the density and strength are not negatively affected thereby. The grain size of the filler is expediently matched to the grain size or the grain-size distribution of the moulding material.

In order to guarantee the necessary stability of the cores after the core-shooting, binders are added to the moulding material before the core-shooting. All binders are possible that are completely water-soluble after the hardening process and wet the moulding material and, if applicable, the fillers well and wherein the mixture of these substances can be shaped by means of core-shooting to form cores. Generally, silicate binders are suitable if they are water-soluble. The water-soluble alkali phosphates and ammonium phosphates or monoaluminium phosphate binders can also be used. Binders made from soluble water glass are preferred. The quantity added is dependent on the water-glass modulus, 1 to 5, and, depending on the wetting behaviour, lies between 0.5% by weight and 15% by weight.

The properties of a mixture of moulding material, if applicable filler and binder, can be affected by the controlled addition of additives. The precondition here as well is that as well these additives or the reaction products of these additives can be removed completely and without a residue from the hollow space of a work piece by dissolution in water. Depending on the composition of the moulding materials, these additives can be: wetting agents, additions affecting the consistency of the mixture, lubricants, de-agglomeration additions, gelling agents, additions that change the thermophysical properties of the core, for example the thermal conductivity, additions that prevent the metal/plastics material from sticking to the cores, additions that result in better homogenization and miscibility, additions that increase the storage life, additions that prevent premature hardening, additions that prevent smoke- and condensate-formation during casting and also additions that result in the acceleration of the hardening. These additives are known to the person skilled in the art of production of conventional cores. The quantity of them that is added is determined by the type and composition of the moulding material.

So that the cores have the necessary strength after core-shooting, it can be necessary, depending on the composition of the core material, to use catalysts that are matched thereto and initiate and accelerate the hardening.

In the case of gaseous catalysts, the gas that affects the core material, in particular for hardening and drying the cores, can be blown into the still closed mould after shooting. The pressure can be lower than when shooting the cores and amount to approximately 5 bar.

Thermal after-treatment of the cores at temperatures that can amount to up to 500° C. is also possible. As a rule, thermal treatment already takes place during the shaping in the mould as a result of heating the latter to a temperature that is matched to the core material.

The core material is composed of the moulding material and the binder and also the added substances, such as fillers, additives and catalysts, if they are required. All the substances can be homogeneously mixed by means of known mixing units. The quantity of binder and additions added is to be selected as a function of the intended use of the cores and determines the surface quality and also the density and strength of the cores.

The preparation of the core materials can be effected separately from the core-shooting process, with, if applicable, suitable protective measures having to be provided in order to prevent agglomeration and premature hardening. For example, depending on the composition of the core material, preparation, transportation and storage can also be effected under protective gas.

Substances that change the properties of the other substances of the core material, in particular those that are necessary for hardening, are advantageously input directly into the core-shooting machine. Thorough mixing is then effected in the gas stream transporting the other substances into the mould. The core material is blown into the mould at pressures between 1 bar and 10 bar, matched to the composition of the core material or to the filling properties and flow properties of the mass. In this connection, the filling pressure is dependent on the grain-size distribution or the grain size and grain shape. Fine-grained salts generally require higher shooting pressures.

The surface quality of the cores in accordance with the invention can be adjusted so that no slip needs to be used. If, nevertheless, surface-treatment with a slip is provided, the slip should also be completely water-soluble. A salt slip that consists of the same salt or a salt that is comparable with the moulding material in terms of its behaviour is preferred. The slip can be applied by the usual methods by dipping, spraying, spreading or painting.

The invention is explained in greater detail with the aid of exemplary embodiments.

Production of Cores from Sodium Chloride (NaCl):

Cores made from NaCl are suitable in particular for light-metal casting, for example for aluminium cast alloys, in which the cores are subjected to temperatures below 800° C. NaCl is used in the grain-size range of 0.063 mm to 2 mm, preferably in the Gaussian distribution, in which case the distribution can be multimodal. Water glass is particularly suitable as a binding agent, with the quantity added being determined by the water-glass modulus, 1 to 5, and lying between 0.5 and 15% by weight. Other water-soluble silicate compounds are likewise preferably used. The temperature of the mould is matched to the composition of the core materials in a temperature range from room temperature to 500° C. Hardening of the cores can be effected by gassing, for example with CO₂, and/or by the action of temperature.

After the core-shooting, the cores have, as a function of their composition and possible heat-treatment, a density of 0.9 g/cm³ to 1.8 g/cm³, a 3-point bending strength of 100 N/cm² to 750 N/cm² and a surface quality Ra, depending on the grain size, between 5 μm and 200 μm. The cores are storable. After the work pieces have been cast, the cores can be removed from the hollow spaces without a residue by complete dissolution in water.

Cores made from NaCl with an average grain size D50 of 0.7 mm were produced with 5% by weight water glass of modulus 4. NaCl and water glass were mixed homogeneously in a conventional mixer and poured into a core-shooting machine. The core material was shot into the mould with air at a pressure of 4 bar. The mould was at room temperature. After shooting, gassing with CO₂ was effected for hardening.

### Important Properties of the Cores:

| | | |
|---|---|---|
| Density: | 1.4 | g/cm³ |
| 3-point bending strength: | 180 | N/cm² |
| Surface quality Ra: | 32 | μm |

Production of Cores from Potassium Sulphate (K₂SO₄):

Cores made from K₂SO₄ are particularly suitable for copper-based materials, brass and bronze, where the cores are subjected to higher temperatures than in the case of the aluminium cast. K₂SO₄ can likewise be used in the grain-size range of 0.063 mm to 2 mm, preferably in the Gaussian distribution and, if applicable, multimodally. Water glass is likewise particularly suitable as a binding agent, with the quantity added being determined by the water-glass modulus, 1 to 5, and lying between 1 and 10% by weight. Other water-soluble silicate compounds are likewise preferably used. The temperature of the mould is matched to the composition of the core materials in a temperature range from room temperature to 500° C. Hardening of the cores can be effected by gassing and/or by the action of temperature.

After the core-shooting, the cores have, as a function of their composition and possible heat-treatment, a density of 0.8 g/cm³ to 1.6 g/cm³, a 3-point bending strength of 80 N/cm² to 600 N/cm² and a surface quality Ra, depending on the grain size, between 10 μm and 250 μm. The cores are storable. After the work pieces have been cast, the cores can be removed from the hollow spaces without a residue by complete dissolution in water.

Cores made from K₂SO₄ with a grain size D50 of 0.85 mm were produced with 8% by weight water glass of modulus 2.5. K₂SO₄ and water glass were mixed homogeneously in a conventional mixer and poured into a core-shooting machine. The core material was shot into the mould with air at a pressure of 4 bar. The mould had a temperature of 180° C. After shooting, gassing with CO₂ was effected for hardening.

### Important Properties of the Cores:

| | | |
|---|---|---|
| Density: | 1.25 | g/cm³ |
| 3-point bending strength: | 145 | N/cm² |
| Surface quality Ra: | 80 | μm. |

1-33. (canceled)

34. A core for use as a hollow-space place-holder, in the case of the production of metallic and non-metallic molded bodies, comprising a core material comprising salt or a mixture of salts as molding material and optionally additional substances, such as fillers, binders, additives and catalysts, wherein the core material after hardening is completely soluble in water and can be removed with water from the molded bodies without a residue, and in that the core can be produced from salt or salts in a non-liquid form and the, optionally additional substances in accordance with the core-shooting process at pressures that are matched to the composition of the core material.

35. A core according to claim 34, produced at pressures of 1 bar to 10 bar.

36. A core according to claim 34, wherein the molding material is a chloride of an alkali or alkaline-earth element, a water-soluble sulphate or nitrate of an alkali or alkaline-earth element, or a water-soluble ammonium salt.

37. A core according to claim 34, wherein the core comprises water-soluble salts, whose point of decomposition or melting point lies above the temperature of the liquid metal, the melt, or the injected plastics material.

38. A core according to claim 34, wherein the core comprises a single salt as molding material or of a mixture of salts as molding material.

39. A core according to claim 34, wherein the grain sizes of the molding materials lie in the range of 0.01 mm to 2 mm, preferably as a Gaussian distribution, depending on the material, desired surface quality and precision of the contours of the work piece to be cast from metal or injection-molded from plastics material.

40. A core according to claim 34, wherein a portion of the core material comprises a water-soluble filler, in that the grain size of the filler is matched to the grain size of the molding material, and in that the proportion of the filler in the core material amounts to 30% by weight.

41. A core according to claim 34, wherein they contain one or more water-soluble binders, in a proportion as a function of the specific surface, the wetting behaviour and the grain-size distribution, and in that these binders are preferably water-soluble silicate compounds, in particular water glasses, alkali phosphates, ammonium phosphates and monoaluminum phosphate.

42. A core according to claim 41, wherein the binder is a water glass, and in that the proportion, depending on the wetting behaviour and water-glass modulus, lies between 0.5% by weight and 15% by weight.

43. A core according to claim 34, wherein the core contain water-soluble additives that are matched to the core material.

44. A core according to claim 34, wherein the core contain water-soluble catalysts that are matched to the core material.

45. A core according to claim 34, wherein the core material comprises sodium chloride as molding material with a grain size of between 0.063 mm to 2 mm, preferably as a Gaussian distribution, and water glass as a binder in a proportion of 0.5 and 15% by weight, as a function of the specific surface, the wetting behaviour and the grain-size distribution and matched to the water-glass modulus, and in that the core have a density of 0.9 g/cm³ to 1.8 g/cm³, a 3-point bending strength of 100 N/cm² to 750 N/cm² and a surface quality Ra of 5 μm to 200 μm.

46. A core according to claim 45, wherein the core material comprises sodium chloride as molding material with a gain size of 0.7 mm and water glass of modulus 4 in a proportion of 5% by weight, compressed with a shooting pressure of 4 bar in a mould at room temperature and hardened with CO₂, and in that the density amounts to 1.4 g/cm³, the 3-point bending strength amounts to 180 N/cm², and the surface quality Ra amounts to 32 μm.

47. A core according to claim 34, wherein the core material comprises potassium sulphate as molding material with a grain size between 0.063 mm and 2 mm, preferably as a Gaussian distribution, and water glass as a binder in a proportion of 1 to 10% by weight, as a function of the specific surface, the wetting behaviour and the grain-size distribution and matched to the water-glass modulus, and in that the core have a density of 0.8 g/cm³ to 1.6 g/cm³, a 3-point bending strength of 80 N/cm² to 600 N/cm² and a surface quality Ra of 10 μm to 250 μm.

48. A core according to claim 34, wherein the core material is potassium sulphate as molding material with a grain size of 0.85 mm and water glass of modulus 2.5 in a proportion of 8% by weight, compressed with a shooting pressure of 4 bar in a mould heated to 180° C. and hardened with CO₂, and in that the density amounts to 1.25 g/cm³, the 3-point bending strength amounts to 145 N/cm², and the surface quality Ra amounts to 80 μm.

49. A method for producing a core for use as a hollow-space place-holder, in the case of the production of metallic and non-metallic molded bodies, from a core material consisting of salt or a mixture of salts as molding material and, if applicable, additional substances, such as fillers, binders, additives and catalysts, wherein the core material which is completely soluble in water and can be removed with water from the molded bodies without a residue and comprises salt or salts in a non-liquid form and the additional water-soluble substances that are additional [sic] and matched in terms of grain size to the molding material is homogeneously mixed and shaped to form core in accordance with the core-shooting process, at pressures matched to the composition of the core material, the grain-size distribution or the grain size and grain shape.

50. A method according to claim 49, wherein the core is shaped at pressures of 1 bar to 10 bar.

51. A method according to claim 49, wherein a high degree of space-filling of the moulds by the core material is achieved by mixing salts as molding material and, if applicable, additional substances with grain sizes of different distribution curves, preferably by means of a bi- or tri-modal grain distribution of the mixture.

52. A method according to claim 49, wherein chlorides of alkali and alkaline-earth elements, such as in particular sodium chloride, potassium chloride and magnesium chloride, the water-soluble sulphates and nitrates of alkali and alkaline-earth elements, such as in particular potassium sulphate, magnesium sulphate, and also the water-soluble ammonium salts, such as in particular ammonium sulphate, are selected as molding material, which are homogeneously mixed, if applicable with the additional substances, and shaped to form core.

53. A method according to claim 49, wherein molding materials with grain sizes in the range of 0.01 mm to 2 mm are used, preferably as a Gaussian distribution, depending on material, desired surface quality and precision of the contours of the work piece to be cast from metal or injection-molded from plastics material.

54. A method according to claim 49, wherein filler or fillers is or are added in a proportion of up to 30% by weight of the core material, and in that the grain size of the filler is matched to the grain size of the molding material.

55. A method according to claim 49, wherein one or more binders is or are added in a proportion as a function of the specific surface, the wetting behaviour and the grain-size distribution, and in that these binders are preferably water-soluble silicate compounds, in particular water glasses, alkali phosphates, ammonium phosphates and monoaluminum phosphate.

56. A method according to claim 55, wherein a water glass is added as a binder as a function of the wetting behaviour and water-glass modulus in a proportion of 0.5% by weight to 15% by weight.

57. A method according to claim 49, wherein water-soluble additives are added that are matched to the core material.

58. A method according to claim 49, wherein water-soluble catalysts are added that are matched to the core material.

59. A method according to claim 49, wherein the core is gassed for the purposes of hardening after the shooting with gases that are matched to the core material.

60. A method according to claim 59, wherein the gassing is effected with CO₂.

61. A method according to claim 59, wherein the pressure during the gassing amounts to up to 5 bar.

62. A method according to claim 59, wherein core is hardened after the shooting by means of heat treatment matched to the core material at temperatures up to 500° C.

63. A method according to claim 59, wherein in order to produce core of sodium chloride as molding material with a grain size between 0.063 mm to 2 mm, preferably as a Gaussian distribution, and water glass as a binder in a proportion of 0.5 and 15% by weight, as a function of the specific surface, the wetting behaviour and the grain-size distribution and matched to the water-glass modulus, a core material is produced by homogeneously mixing the substances and is contained at a pressure of 1 bar to 10 bar in a mould, which, as a function of the composition of the core material, has a temperature from room temperature to 500° C., and in that the core material is hardened, if applicable by gassing and/or heat treatment, so that the core achieve a density of 0.9 g/cm³ to 1.8 g/cm³, a 3-point bending strength of 100 N/cm² to 750 N/cm² and a surface quality Ra of 5 μm to 200 μm.

64. A method according to claim 63, wherein the molding material sodium chloride with a grain size of 0.7 mm and water glass of modulus 4 in a proportion of 5% by weight is compressed with a shooting pressure of 4 bar in a mould at room temperature and subsequently is hardened with CO₂ at a pressure of 1.5 bar, with a density of 1.4 g/cm³, a 3-point bending strength of 180 N/cm² and a surface quality Ra of 32 μm being achieved.

65. A method according to claim 49, wherein in order to produce core of potassium sulphate as molding material with a grain size between 0.063 mm to 2 mm, preferably as a Gaussian distribution, and water glass as a binder in a proportion of 1 to 10% by weight, as a function of the specific surface, the wetting behaviour and the grain-size distribution and matched to the water-glass modulus, a core material is produced by homogeneously mixing the substances and is contained at a pressure of 1 bar to 10 bar in a mould, which, as a function of the composition of the core material, has a temperature from room temperature to 500° C., and in that the core material is hardened, if applicable by gassing and/or heat treatment, so that the core achieve a density of 0.8 g/cm³ to 1.6 g/cm³, a 3-point bending strength of 80 N/cm² to 600 N/cm² and a surface quality Ra of 10 μm to 250 μm.

66. A method according to claim 65, wherein the molding material potassium sulphate with a grain size of 0.85 mm and water glass of modulus 2.5 in a proportion of 8% by weight is compressed with air with a shooting pressure of 4 bar in a mould heated to 180° C. and subsequently is hardened with CO₂ at a pressure of 1.5 bar, with a density of 1.25 g/cm³, a 3-point bending strength of 145 N/cm² and a surface quality Ra of 80 μm being achieved.
